(19) United States
(12) Patent Application Publication
(10) Pub. No.: US 2011/0181927 A1
(43) Pub. Date: Jul. 28, 2011

(54) Systems And Methods For Detecting Media Edges In An Automatic Document Feeder

(76) Inventors: Mark A. Overton, Escondido, CA (US); Michael Scott Gray, Encinitas, CA (US); Craig T. Johnson, San Diego, CA (US)

(21) Appl. No.: 13/055,985

(22) PCT Filed: Aug. 11, 2008
(86) PCT No.: PCT/US08/72777

§ 371 Date: Apr. 12, 2011

(51) Int. Cl. H04N 1/04

(52) U.S. Cl. 358/498

(57) ABSTRACT

Systems and methods are disclosed for detecting media edges in an automatic document feeder including a scan backing strip that is colored to contrast with the color of a medium being fed through the automatic feeder. Logic instructions are included that cause a computer processor to detect when the medium is being fed through the automatic document feeder based on the difference in color between the scan backing strip and the medium.

### BACKGROUND

Many of today's electronic devices interact with some form of media in a repeated automatic fashion. Examples of media include paper, cardboard, fabric, polymers and the like. Such electronic devices typically include feed devices that automatically and repeatedly supply individual sheets or pieces of media to a mechanism that interacts with the individual sheets or pieces of media. For example, many scanning electronic devices include automatic document feeders that feed individual sheets along a path to a scanning mechanism. Printers, facsimile machines, and copiers frequently include an automatic document feeder that feeds individual sheets of media along a path to an inkjet or an electrophotographic printing mechanism.

### SUMMARY

Systems and methods are disclosed for detecting media edges in an automatic document feeder including a scan backing strip that is colored to contrast with the color of a medium being fed through the automatic document feeder. Logic instructions are included that cause a computer processor to detect when the medium is being fed through the automatic document feeder based on the difference in color between the scan backing strip and the medium.

### BRIEF DESCRIPTION OF THE DRAWINGS

Embodiments of the invention relating to both structure and method of operation may best be understood by referring to the following description and accompanying drawings.

FIG. 1 depicts an embodiment of an electronic device with automatic document feed and scanning capability.

FIG. 2 is a cross-sectional view of an embodiment of automatic document feed components that can be used in the electronic device of FIG. 1.

FIG. 3 is a flow chart of an embodiment of process for detecting the position of media in the automatic document feeder of the electronic device of FIG. 1.

### DETAILED DESCRIPTION

In some electronic devices such as printers, scanner, copiers, and facsimile machines, among others, it may be desirable to accurately and precisely detect the edge of the media as it is being fed along the media path to properly sequence the feeding of individual sheets, to initiate scanning, copying, or printing at the proper time, and to identify malfunctioning of the electronic device or jamming of the media within the device.

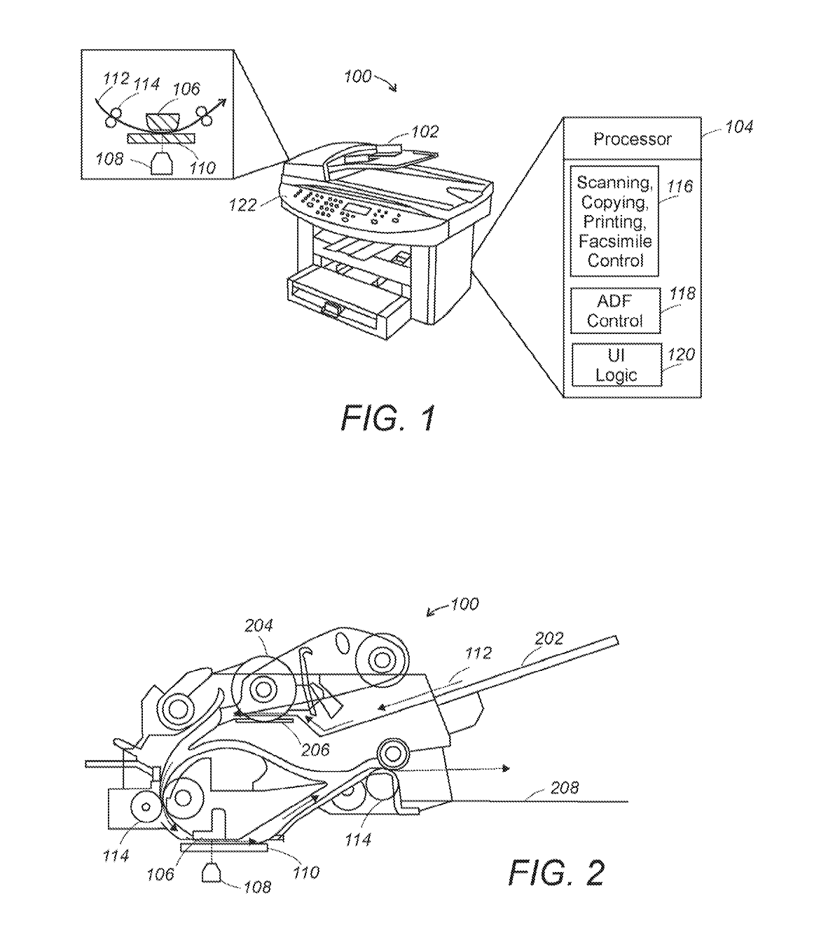

FIG. 1 illustrates an apparatus for an electronic device 100 in accordance with an embodiment of the invention that includes an automatic document feeder (ADF) 102 (of which only a media feed tray is shown), a computer processor 104, a scan backing strip 106, a scanning sensor 108, glass platen 110 between scan backing strip 106 and scanning sensor 108, a media path 112 between glass platen 110 and scan backing strip 106, one or more media transfer members (shown as pairs of rollers) 114 configured to contact the medium and to move the medium along the media path 112, and a media interaction device such as a print head (not shown) that interacts with the medium to transfer image data onto the medium. Electronic device 100 can further include scanning, copying, printing, and facsimile control logic instructions 116, ADF control logic instructions 118, and user interface logic instructions 120 that interface with a user-accessible control panel 122 on electronic device 100.

At least a portion of the scan backing strip 106 is colored to contrast with the color of a medium being fed through the automatic document feeder 102. Computer processor 104 executes scanning, copying, printing, and facsimile control logic instructions 116 to detect when medium is being fed through the automatic document feeder 102 based on differential color values of the scan backing strip 106 and the medium. In other electronic devices, the scan backing strip is usually white making it difficult if not impossible to detect the edges of medium such as white paper. The ability to detect edges of the medium based on the color difference between the medium and the scan backing strip 106 enables electronic device 100 to function without a separate edge sensor as required in conventional electronic devices.

During operation, scanning sensor 108 scans a row of pixels and detects red-green-blue (RGB) color values of at least some of the pixels. If the medium is in the line of sight of scanning sensor 108, the pixels will have RGB values corresponding to the color of the medium. If the medium is not adjacent scanning sensor 108, the pixels have RGB values corresponding to the color of scan backing strip 106. Logic instructions 116 determine whether the color of at least a portion of the pixels is within a preselected tolerance. When the color of a threshold number of the pixels is within the preselected tolerance, logic instructions 116 can determine that the scanning sensor 108 is scanning the medium instead of the scan backing strip 106 or vice versa. For example, logic instructions 116 can be configured to cause the computer processor 104 to control the scanning sensor 108 to scan a plurality of RGB pixels, and determine differential color values for the pixels to be the amount of blue in the pixels minus the amount of red in the pixels. Logic instructions 116 can further determine that the medium is adjacent scanning sensor 108 when the differential color value of a minimum number of the pixels is greater than a predetermined level or vice versa.

The color of the scan backing strip 106 can be selected so that differential color values are maximized for the color of the scan backing strip compared to the color of the medium. For example, the color of the scan backing strip 106 can be light yellow so that blue minus red color values of a plurality of scanned pixels of scan backing strip 106 is maximized for the color of the scan backing strip 106. Other color combinations can be used with corresponding changes to logic instructions 116 to determine appropriate differential color values of the scan backing strip 106 and the medium. The color-tolerance on the scan backing strip 106 is typically tight so scan backing strip 106 can be distinguished from the medium even when the color of the medium is close to the color of the scan backing strip 106.

Processor 104 generally comprises a processor unit configured to generate control signals. For purposes of this disclosure, the term “processor unit” shall mean a conventionally known or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Processor 104 is not limited to any specific combination of hardware circuitry and software, nor to any particular source for the instructions executed by the processing unit. In the particular embodiment illustrated, processor 104 generates such control signals based at least in part upon signals from scanning sensor 108.

In some aspects, electronic device 100 can include means such as logic instructions 116 for detecting an edge of a medium in an automatic document feeder. For example, logic instructions 116 can control operation of a scanning sensor 108 to electronically scan a row of pixels in a scanning area along media path 112. Differential color values for at least a portion of the pixels can be determined with the differential color values being approximately a first predetermined value when a scan backing portion is being scanned and another value when the medium is being scanned. In some implementations, the color of the scan backing portion is selected so that differential color values are maximized between the color of the scan backing portion and the color of the medium. For example, if the color of the scan backing strip is light yellow, the blue minus red color values are maximized between the color of the scan backing portion and the color of white medium such as printer/copier paper.

Means for controlling a media transfer member configured to contact the medium and to move the medium along the media path can include rollers 114 as well as other devices configured to move the medium along the media path under automated control according to logic instructions 116, 118, 120.

Referring to FIG. 2, a cross-sectional view of an embodiment of ADF 102 that can be used in the electronic device of FIG. 1 is shown. A media path 112 is shown by dashed arrows routed through input tray 202, pick roller 204, prescan rollers 114, ADF glass 110, post scan rollers 114, and output tray 208. Rollers 104, 114 act as media transfer members to contact the medium and to move the medium along the media path 112. Scan backing strip 106 is positioned in the media path 112 between the prescan rollers 114 and post scan rollers 104 and on an opposite side of the media path 112 from the scanning sensor 108. Rollers 104, 114 are driven by one or more actuators (not shown), and computer processor 104 controls operation of the actuators based on the position of the medium in media path 112 and operating sequence of scanning sensor 108.

Scanning sensor 108 can include a suitable sensor device such as a contact image sensor (CIS) or a charge coupled device (CCD), and a color-separation method to collect optical information about the document and transform the information into an image file. The scanner sensor 108 illuminates a small strip of the medium called a raster line. Scanning sensor 108 can typically read an entire width of the medium passing along a media path 112. The scanning sensor 108 senses and records light reflected from the scan backing strip 106 or the medium. The ADF 102 advances the medium to the next raster line. The image data is collected and sent to a formatter. The formatter prepares the image data for output as a facsimile, directs the image data to a computer as scanner output, or to a printer as printer output. The image data collected has a specific resolution, such as 600 pixels per inch (ppi). Each pixel has 8 or 16 bits for each of the three colors for a total of 24 or 48 bits per pixel.

Electronic device 100 can include components configured to transmit image data to the medium in the form of ink, toner or other image-forming material. In such an embodiment, electronic device 100 provides a printing mechanism specifically configured to deposit the image-forming material upon the surface of the medium. For example, in one embodiment, the printing mechanism comprises a printhead configured to deposit ink upon the medium. The printing mechanism may comprise a page-wide array of printheads or may comprise a printhead scanned across the medium as the medium moves relative to the printhead. In yet another embodiment, the printing mechanism may comprise an electrophotographic system including a photoconductive drum and configured to apply toner to the medium.

Scanning sensor 108 can be configured to remain stationary and scan medium as it is fed through ADF 102 and/or move relative to the medium when the medium is placed on a flatbed. If electronic device 100 detects a document in the ADF 102 when a copy or scan is initiated, scanning sensor 108 can move to a position adjacent scan backing strip 106 and stop. The image is acquired as the paper is fed through the ADF 102 past the scanning sensor 108. If no document is detected in the ADF 102, or if the model does not have an ADF 102, the scanning sensor 108 acquires the image through the flatbed glass while slowly moving along a scan track.

ADF 102 feeds individual sheets of media to scanning sensor 108. For purposes of this disclosure, the term “media” means any material in general sheet form upon which an image is already formed or upon which an image may be formed or may have material deposited thereon. Examples of media include fabrics, polymers, cellulose-based materials (i.e., paper, cardboard and the like) or combinations thereof. Although input tray 202 is illustrated as supporting a stack of media in an angular orientation, input tray 202 may alternatively be configured to support media in a vertical, horizontal, or other suitable orientation.

When ADF 102 receives a copy or scan command, a motor engages a gear train to lower pick roller 204 and move the medium into ADF 102. A single medium continues through media path 112 and logic instructions 116 alert scanning sensor 108 to start scanning. Scanning sensor 108 will detect scan backing strip 106 before and after the medium moves over scanning sensor 108. When scanning sensor 108 detects a predetermined change in color of at least some of the pixels most recently scanned, scanning sensor 108 acquires the image on the medium, one raster line at a time, until another predetermined change in color, which indicates the trailing edge of the medium. The medium is then ejected to output tray 208. The pick and feed steps are repeated as long as media is detected in the ADF input tray 202.

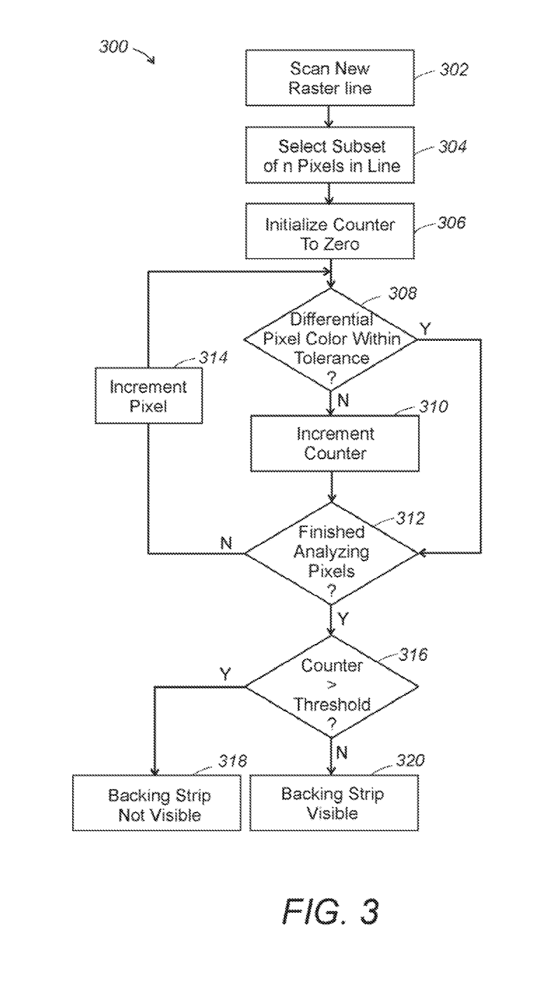

Referring now to FIG. 3, a flow diagram of an embodiment of a method for detecting an edge of a medium in the electronic device of FIG. 1 is shown. Process 302 can include scanning a new raster line once the ADF detects one or more medium in the input tray and receives a command to start scanning the medium. A scanning sensor is positioned on one side of the media path and the scan backing portion is positioned on another side of the media path.

In order to reduce latency, process 304 can include selecting a subset of the pixels in the raster line to test for a predetermined change in color. Process 306 can include initializing a pixel counter to zero before determining differential color values for the pixels.

Process 308 includes determining whether differential color values for at least a portion of the pixels is within a specified tolerance. The color of the scan backing portion is selected so that differential color values of the pixels being analyzed are maximized between the color of the scan backing portion and the color of the medium. For example, the color of the scan backing strip can be light yellow and blue minus red color values of the pixels is maximized between the color of the scan backing portion and a white medium such as plain copier and printer paper. If the differential pixel color values are within the specified tolerance, process 310 includes incrementing the pixel counter. Method 300 transitions to process 312 if the differential pixel color values are not within the specified tolerance, as well as after the pixel counter is incremented in process 310.

Process 312 determines whether all of the selected subset of pixels have been analyzed. If not, process 314 increments the pixel and transitions back to process 308. If the differential color values of all of the pixels in the subset have been analyzed, process 312 transitions to process 316.

Process 316 determines whether the pixel counter is greater than a threshold number. If so, process 318 indicates that the medium is over the scanning sensor and the backing strip is not visible. If the counter is less than the threshold, process 320 indicates that the backing strip is visible to the scanning sensor. Logic instructions 116 (FIG. 1) can use the indicators provided by processes 318 and 320 to determine when the medium is between the scan backing strip 108 and scanning sensor 108.

The various functions, processes, methods, and operations performed or executed by electronic device 100 (FIG. 1) can be implemented as programs that are executable on various types of processing units 104 such as controllers, central processing units, microprocessors, digital signal processors, state machines, programmable logic arrays, and the like. Logic instructions 116, 118, 120 can be stored on any computer-readable medium or memory device for use by or in connection with any computer-implemented system or method. A computer-readable medium is an electronic, magnetic, optical, or other physical memory device or means that can contain or store a computer program for use by or in connection with electronic device 100, method 300 (FIG. 3), process, or procedure. Programs can be embodied in logic instructions that are executed by a computer-readable medium for use by or in connection with an instruction execution system, device, component, element, or apparatus, such as a system based on a computer or processor, or other system that can fetch instructions from an instruction memory or storage of any appropriate type.

Electronic device 100 can be configured to interface with one or more computer and/or telephone networks via suitable communication links such as any one or combination of plain old telephone service (POTS), T1, ISDN, or cable line, a wireless connection through a cellular or satellite network, or a local data transport system such as Ethernet or token ring over a local area network. Electronic device 100 may be a printer, facsimile, scanner, copier, processing device with memory and network interface, or other suitable device for scanning, storing and communicating digital image data and logic instructions.

The illustrative block diagrams and flow charts provided herein depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. An apparatus comprising:
an automatic document feeder;
a computer processor;
a scan backing strip, at least a portion of the scan backing strip being colored to contrast with the color of a medium being fed through the automatic document feeder; and
logic instructions on computer readable medium configured to cause the computer processor to detect when the medium is being fed through the automatic document feeder based on the difference in color between the scan backing strip and the medium.

2. The apparatus of claim 1, further comprising:
a scanning sensor;
logic instructions configured to cause the computer processor to:
scan a row of pixels using the scanning sensor;
determine whether the color of at least a portion of the pixels is within a preselected tolerance; and
determine that the medium has not reached the scanning sensor when the color of a subgroup of the at least a portion of the pixels is within the preselected tolerance.

3. The apparatus of claim 1, further comprising
a scanning sensor;
logic instructions configured to cause the computer processor to:
scan a row of pixels using the scanning sensor;
determine whether the color of at least a portion of the pixels is within a preselected tolerance; and
determine that the scanning sensor is scanning the scan backing strip when the color of a subgroup of the at least a portion of the pixels is not within the preselected tolerance.

4. The apparatus of claim 1, further comprising:
a scanning sensor;
logic instructions configured to cause the computer processor to:
control the scanning sensor to scan a plurality of pixels;
determine color values of a plurality of red-green-blue pixels to be blue minus red; and
determine that the medium is adjacent a scanning sensor when the color value of a minimum number of the pixels is greater than a predetermined level.

5. The apparatus of claim 1, further comprising the color of the scan backing strip is selected so that differential color values of a plurality of scanned pixels are maximized for the color of the scan backing portion.

6. The apparatus of claim 1, further comprising:
the color of the scan backing strip is light yellow and blue minus red color values of a plurality of scanned pixels is maximized for the color of the scan backing portion.

7. The apparatus of claim 1, further comprising:
a scanning sensor;
a media path including an input area;
a media transfer member configured to contact the medium and to move the medium along the media path; and
the scan backing strip is positioned on an opposite side of the media path from the scanning sensor.

8. A method of detecting an edge of a medium in an automatic document feeder comprising:
electronically scanning a row of pixels in a scanning area along a media path, the automatic document feeder includes a scan backing portion, a scanning sensor positioned on one side of the media path and the scan backing portion positioned on another side of the media path;
determining differential color values for at least a portion of the pixels; and
determining that the edge of the medium is within the scanning area when at least a portion of the differential color values are one of the group consisting of: less than a predetermined value and greater than a predetermined value.

9. The method of claim 8, further comprising:
determining the differential color values of the at least a portion of the pixels to be blue minus red.

10. The method of claim 8, further comprising the color of the scan backing portion is selected so that differential color values of the at least a portion of the pixels are maximized between the color of the scan backing portion and the color of the medium.

11. The method of claim 8, further comprising:
the color of the scan backing strip is light yellow and blue minus red color values of the at least a portion of the pixels is maximized between the color of the scan backing portion and the color of the medium.

12. The method of claim 8, further comprising:
controlling a media transfer member configured to contact the medium and to move the medium along the media path; and
the scan backing strip is positioned on an opposite side of the media path from the scanning sensor.

13. An apparatus for detecting an edge of a medium in an automatic document feeder comprising:
means for controlling operation of a scanning sensor to electronically scan a row of pixels in a scanning area along a media path;
means for determining differential color values for at least a portion of the pixels, the differential color values being approximately a first predetermined value when a scan backing portion is being scanned, the differential color values being another value when the medium is being scanned.

14. The apparatus of claim 13, further comprising the color of the scan backing portion is selected so that differential color values of the at least a portion of the pixels are maximized for the color of the scan backing portion.

15. The apparatus of claim 13, further comprising:
the color of the scan backing strip is light yellow and blue minus red color values of the at least a portion of the pixels is maximized for the color of the scan backing portion.
